(19) United States
(12) Patent Application Publication
(10) Pub. No.: US 2004/0262383 A1
(43) Pub. Date: Dec. 30, 2004

(54) Access control portal

(76) Inventor: Marek A. Zielinski, Toronto (CA)

Correspondence Address: FISH & RICHARDSON PC, 225 FRANKLIN ST, BOSTON, MA, 02110, US

(21) Appl. No.: 10/607,362

(22) Filed: Jun. 26, 2003

(51) Int. Cl. G06K 5/00

(52) U.S. Cl. 235/382

(57) ABSTRACT

An access portal separates an unpaid side of a controlled entry barrier from a paid side. The portal comprises a vestibule connecting the paid and unpaid sides of the controlled entry barrier. A first door separates the vestibule from the unpaid side of the controlled entry barrier and a second door separates the vestibule from the paid side of the controlled entry barrier. A fare collection box is positioned at the unpaid side. A controller is operably connected to the fare collection box. The controller, upon receiving an indication of a collected fare, monitors for a further indication of a collected fare. At the conclusion of the monitoring, the controller cycles the first door, and subsequently, the second door.

### BACKGROUND OF THE INVENTION

The present invention relates to an access portal for controlling access to a restricted area. The access portal may provide controlled access to those with mobility problems and others who may have trouble negotiating turnstiles and the like.

Controlled access to mass transit systems is typically provided by turnstile gates or revolving doors that separate the unpaid side of a controlled entry barrier from a paid side. However, turnstile gates and revolving doors, while effective for the majority of ambulatory users, may be unusable for those with mobility problems, particularly individuals in wheelchairs. To accommodate users in wheelchairs, separate gates may be employed. Some known wheelchair accessible gates must be manually opened and closed. Others may be designed to open automatically once a fare is received. Although access to a mass transit system does not require high security access control, these known wheelchair accessible gates may be easily circumvented and may therefore not be seen as sufficiently secure. This is particularly so where such gates are positioned remotely from a fare collector, or where any proximate fare collector's booth is not always staffed.

Accordingly, there is a need for an access portal which may be used by those who would have trouble with a turnstile or the like, such as those with mobility problems, and which may suitably control access, at least in lower security applications such as access to mass transit systems.

### SUMMARY OF THE INVENTION

A disabled person often travels with an attendant or companion. The present invention facilitates this by providing an access portal which may allow plural (e.g., two) authorized users to contemporaneously pass through the portal. Other features may also be provided in order to enhance the safety and usability of the portal for users, especially those with mobility problems.

According to an aspect of the present invention, there is provided an access portal for separating an unpaid side of a controlled entry barrier from a paid side. The portal comprises a vestibule for connecting the paid and unpaid sides of said controlled entry barrier; a first door for separating the vestibule from the unpaid side of said controlled entry barrier; a second door for separating the vestibule from the paid side of said controlled entry barrier; and a controller. The controller is for operable connection to a fare collection box and is for, upon receiving an indication of a collected fare, monitoring for a further indication of a collected fare. Additionally, the controller is for, at the conclusion of said monitoring, cycling said first door, and subsequently, said second door.

A related method is disclosed as is a computer readable medium to effect the method.

In another aspect, the present invention provides an access portal for controlled entry to a mass transit system. The portal comprises a vestibule for connecting the paid and unpaid sides of a controlled entry barrier; a first door for separating the vestibule from the unpaid side of said controlled entry barrier; a second door for separating the vestibule from the paid side of said controlled entry barrier; and a controller for operable connection to a fare collection box. The controller is for cycling said first door and, subsequently, said second door when a fare is collected by said box.

Further characteristics and advantages of an access portal according to the invention will become apparent from the following description with reference to the accompanying figures.

### BRIEF DESCRIPTION OF THE DRAWINGS

In the figures, which illustrate by way of example only embodiments of this invention:

FIG. 1 is a perspective view of an access portal, viewed from the unpaid side of an access barrier;

FIG. 1A is like perspective view of the access portal, showing the portal in a different state;

FIG. 2 is a perspective view of the portal of FIG. 1, viewed from a paid side of the access barrier;

FIG. 3 is a schematic plan view of the portal of FIG. 1;

FIG. 4 is a cross-sectional view along the lines 4-4 of FIG. 3;

FIG. 5 is a cross-sectional view along the lines 5-5 of FIG. 3;

FIG. 6 is a cross-sectional view along the lines 4-4 of FIG. 3; and

FIG. 7 is a block diagram of the access portal and related environment.

### DETAILED DESCRIPTION

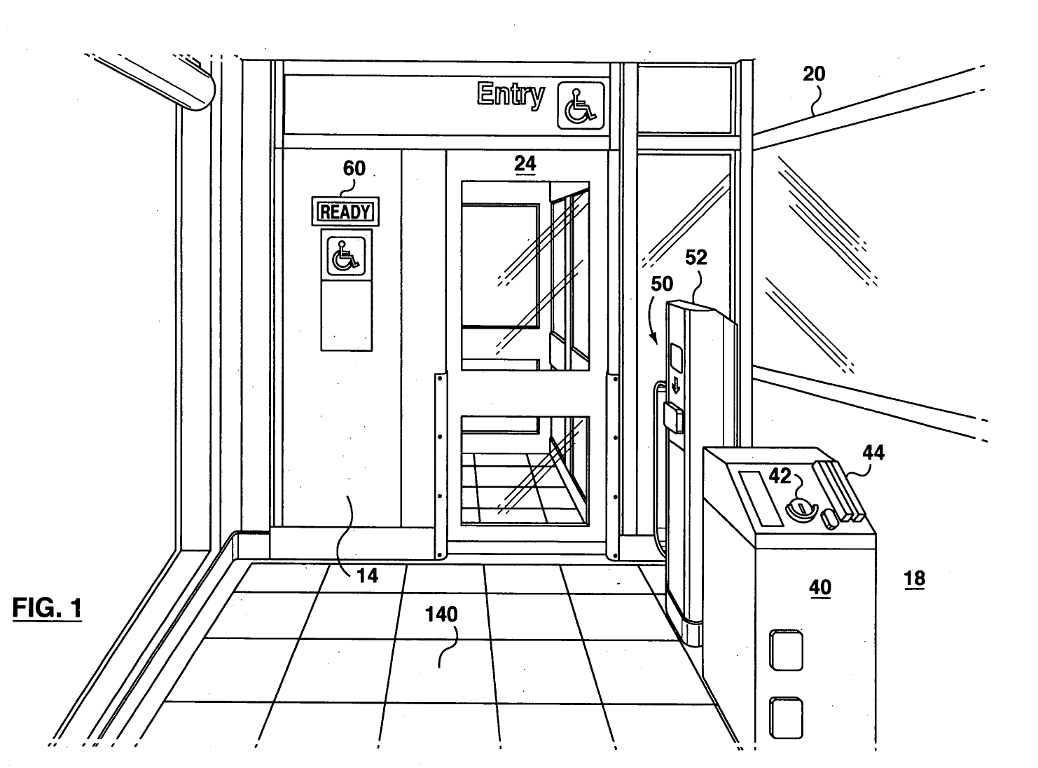

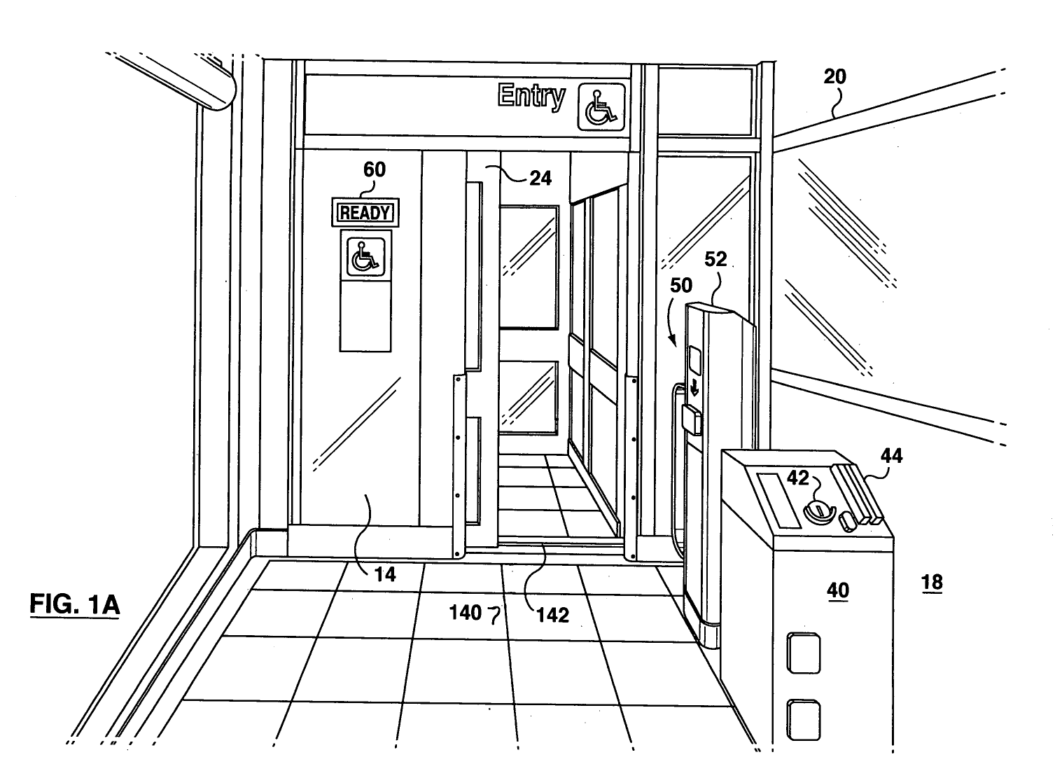

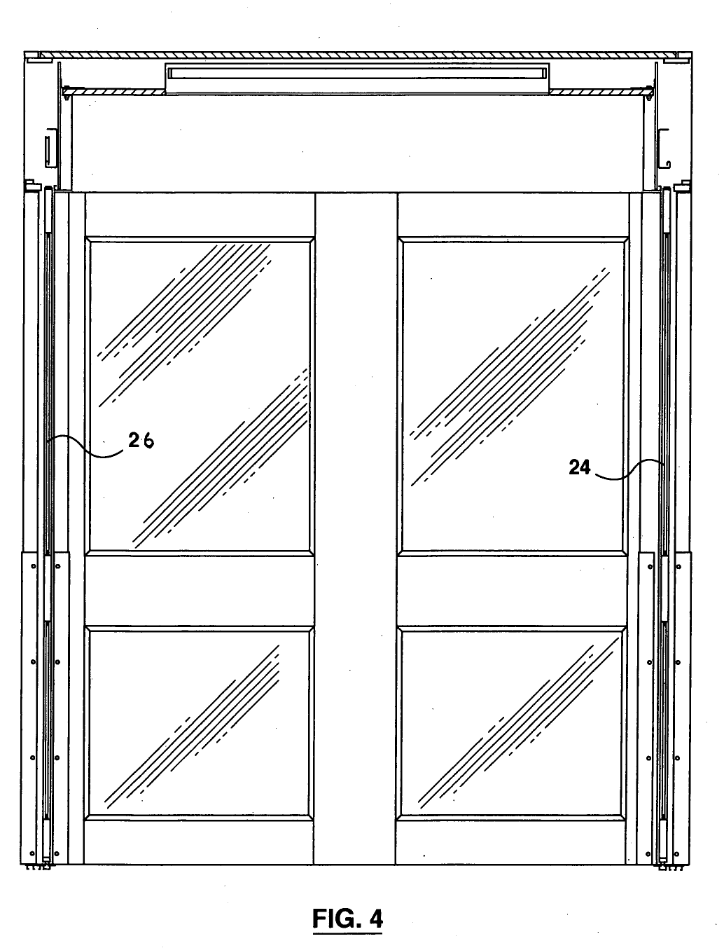

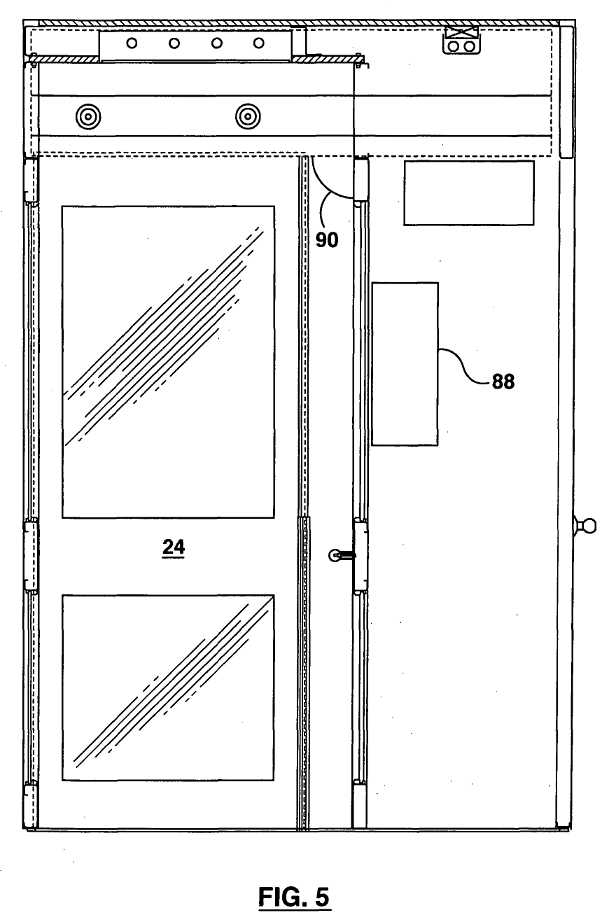

Referencing FIGS. 1 to 6 an access portal 10 comprises a vestibule 12 with a control room 14 extending from one of the walls (wall 15) that defines the vestibule. The vestibule 12 separates an unrestricted (unpaid) side 18 of a barrier 20 from a restricted (paid) side 22 of the barrier. The vestibule is delimited by two doors: a first door 24 separating the vestibule 12 from the unpaid side 18 of barrier 20 and a second door 26 separating the vestibule 12 from the paid side 22 of barrier 20.

With specific reference to FIG. 1, a fare collection box 40 may be positioned proximate door 24 at the unpaid side 18 of barrier 20. The fare collection box may receive fares via a token slot 42 and a card reader 44. A passenger assistance intercom 50 may also be provided housed in a pedestal 52 at the unpaid side 18 of barrier 20. A display 60 (as, for example, a light emitting diode—LED—display) may be provided on a wall of the control room 14 facing the unpaid side 18 of barrier 20.

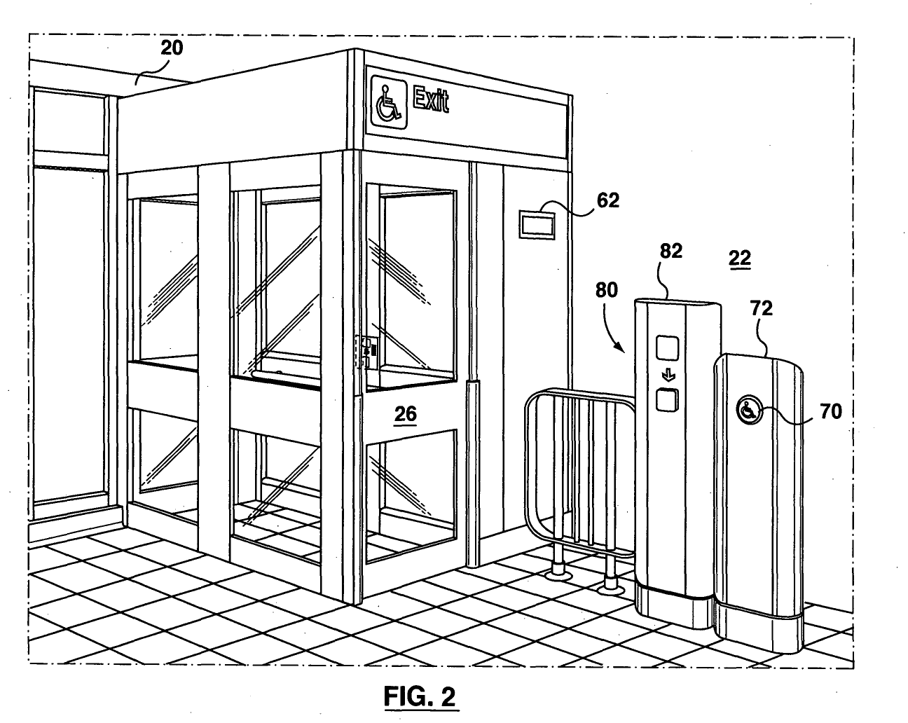

With reference to FIG. 2, at the paid side 22 of barrier 20, an exit request button 70 may be provided on a pedestal 72 and another passenger assistance intercom 80 may be provided housed in a pedestal 82. Further, a display 62 may be provided on a wall of the control room 14 facing the paid side 22 of barrier 20.

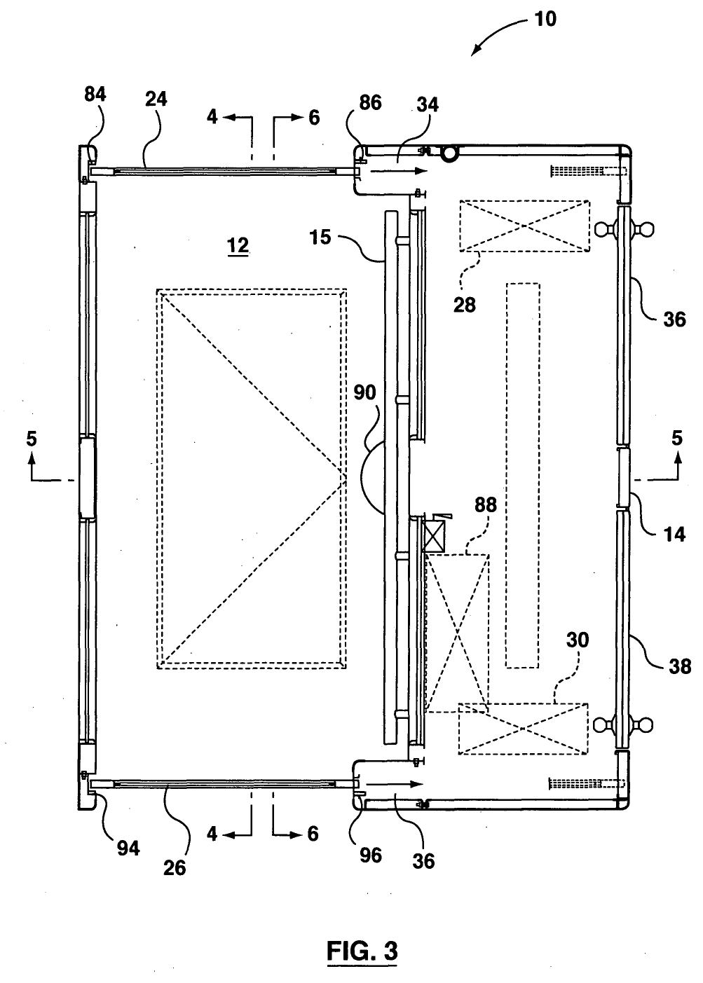

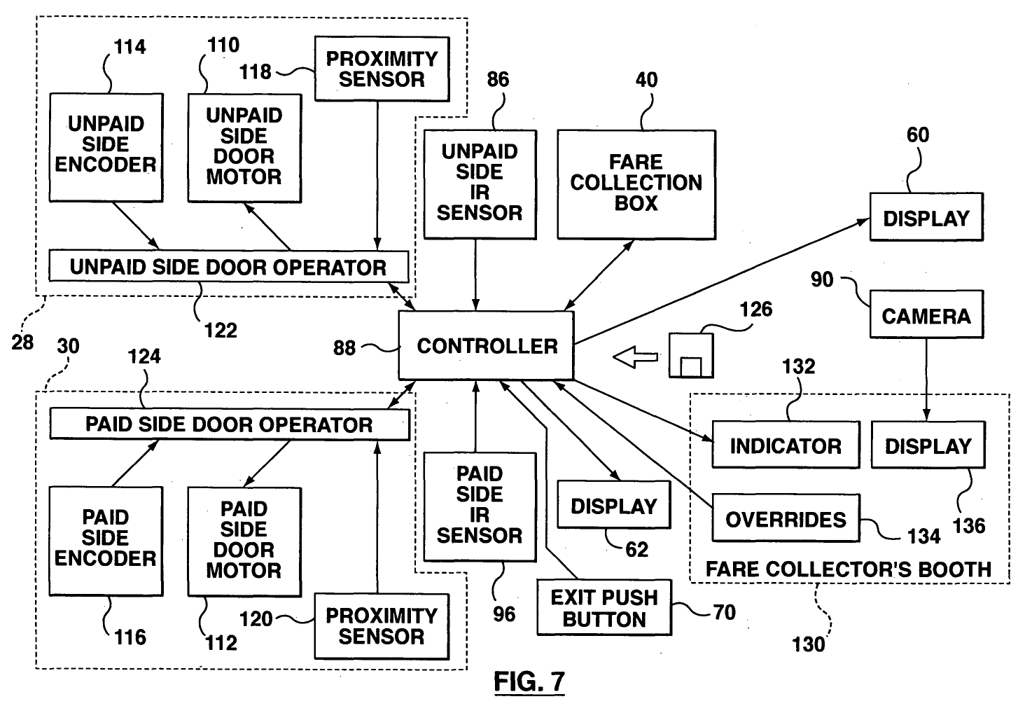

With specific reference to FIG. 3, each of doors 24, 26 may be pocket doors, being received in pockets 34, 36, respectively, of the adjacent control room 14, when open. At each of doors 24 and 26, an infrared sensor 84, 94 may be placed across from an infrared emitter 86, 96. A controller 88 for controlling the functioning of the access portal 10 is housed in control room 14 as is an unpaid side door operator system 28 and a paid side door operator system 30. These door operator systems are known and, as seen in FIG. 7, comprise a door motor 110, 112, an encoder 114, 116 associated with the door motor, and a proximity sensor 118, 120, all associated with a door operator 122, 124. A suitable door operator system is an ECI-2000 closed loop door operator, manufactured by Elevator Components Inc. Access to control room 14 may be had via door 36 or 38. The provision of an adjacent control room avoids the need to house all componentry in the roof of the access portal where it is much less accessible. Additionally, the adjacent control room permits the use of pocket doors, which are seen as safer than, for example, telescoping doors, when the portal is used by the disabled.

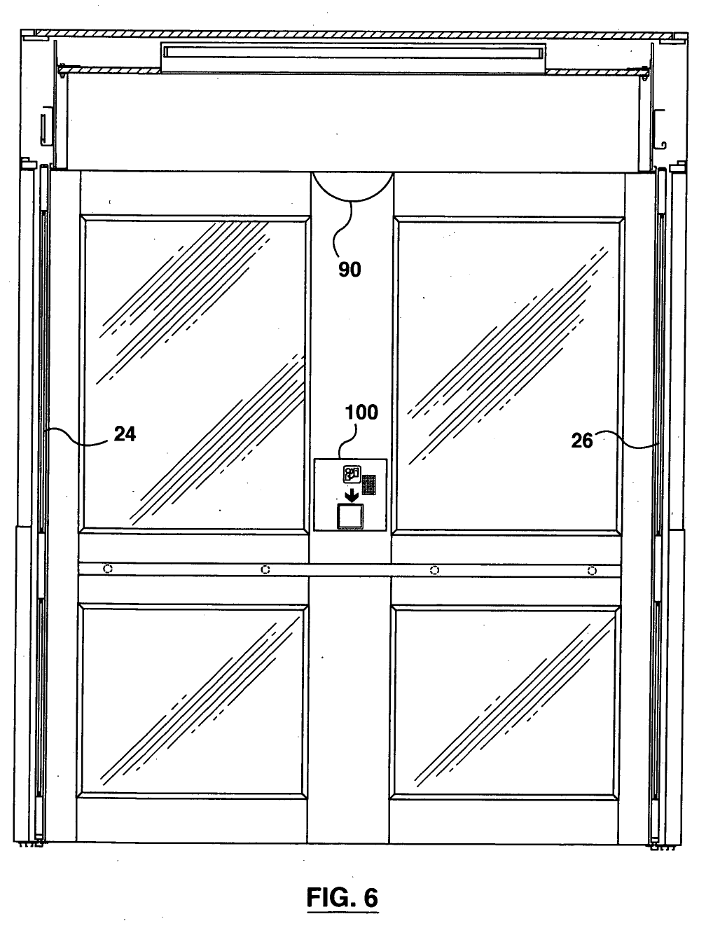

With reference to FIG. 6, the interior of the vestibule may be provided with a camera 90 and a passenger assistance intercom 100.

As is apparent from FIG. 1A, vestibule 12 is floorless, such that the access portal uses the existing floor 140 as its floor. Further, for each of doors 24 (FIG. 1) and 26, a door track 142 is set into a groove in the floor 140. In consequence, there is no step or ramp for a user to negotiate when entering or leaving the vestibule.

Turning to FIG. 7, controller 88 is coupled for two-way communication with unpaid side door operator 122 of door operator system 28, paid side door operator 124 of door operator system 30, and fare collection box 40. The controller receives input signals from infrared sensors 86, 96 and exit pushbutton 70. The controller sends signals to the displays 60, 62. The controller is also operatively connected to components at a manned fare collector's booth 130. More specifically, the controller outputs to an indicator 132 at the booth and receives signals from overrides 134 at the booth. Camera 90 of the access portal outputs a video signal to a display 136 at booth 130. Each door operator 124 receives output signals from an encoder 114, 116 and a proximity sensor 118 and outputs to a door motor 110, 112. The controller 88 may be loaded with software from a computer readable medium 126, which may be, for example, a disk, solid state memory, or a file downloaded from a remote source.

In operation, with reference to FIGS. 3 and 7, it is assumed initially that controller 88 is in a ready state which means that both the unpaid and paid side doors 24 and 26 are closed and the vestibule 12 is (presumed to be) empty, as illustrated in FIG. 1. In this state controller 88 controls display 60 at the unpaid side to display “ENTER READY” and display 62 at the paid side to display “EXIT READY”. From the ready state, an entry mode may be initiated if a token is deposited to fare collection box 40. In such instance, a “token received signal” is sent to controller 88. This starts a (ten second) fare timer, which timer may be implemented in software in the controller. While the fare timer is timing, one or more further tokens may be deposited to the fare collection box. Each additional token deposited will result in a further “token received signal” being sent to the controller. The controller tracks the number of these signals received during the timing of the fare timer. If the total number of “token received signals” reaches a pre-set maximum, the controller immediately sends an inhibit signal to the fare collection box such that will reject any further attempt to deposit a token. This maximum number may be two. As soon as the maximum number is reached or, if the maximum number is not reached, then as soon as the fare timer times out, the controller 88 signals the unpaid side door operator 122 to open door 24 (FIG. 3). The door operator 122 responds to a signal to open the door in a known fashion, using the encoder to judge door position. Simultaneously, the controller changes display 60 to read “ENTER” and display 62 to read “BUSY”. A signal from the door operator 122 apprises the controller when the unpaid side door is fully open. When a person enters the vestibule 12, the infrared beam is broken and the unpaid side IR sensor 86 sends a signal to the controller. This causes the controller to start an unpaid side door closing delay timer. This timer is set to a value intended to allow time for the maximum number of users (e.g., two) to enter vestibule 12. Once this timer times out, the controller signals door operator 122 to close the unpaid side door 24. The door operator functions in a known fashion to close the door, using the proximity sensor to interrupt closing, as necessary, until there is a clear path for the door to close. Once the unpaid side door is closed, the door operator 122 signals controller 88. As soon as the controller receives this signal, it sends a signal to indicator 132 such that the indicator provides a humanly perceptible signal at the fare collector's booth 130 which indicates the number of fares collected. For example, the signal may result in the display of the number of fares collected and/or provide an audible signal indicative of the number of fares collected. This signal allows a booth occupant to check video display 136 to verify that the number of individuals in vestibule 12 matches the number of fares collected. The controller 88 then (possibly after a short delay) signals door operator 124 to open the paid side door 26. Once a user breaks the beam on the paid side, the controller is signalled by the paid side IR sensor 96. This causes the controller to launch a (e.g., one second) paid side door closing delay timer. After this timer expires, the controller signals the door operator 124 to close the paid side door 26. Once the paid side door closes, the entry cycle is complete and the controller uninhibits the fare box 40 and changes the displays to again read ENTER READY and EXIT READY.

By setting the maximum number of fares that will be accepted during a given entry mode, the portal may be suited for use with the disabled. More particularly, a disabled individual often travels with an attendant. Therefore, with a maximum number of permitted fares during one entry mode set at at least two, the attendant may accompany the disabled person through the portal.

It may be noted that if occupants of the vestibule do not leave before the paid side door timer expires and the paid side door closes, they will become trapped in the vestibule. In such instance, the occupants can use intercom 100 (FIG. 6) to communicate with a booth 130 occupant. The booth occupant can then signal the controller 88 using overrides 134 in order to cause either of the paid or unpaid side doors to open.

If, when checking the display 136, the booth occupant observes that the number of individuals in vestibule 12 exceeds the number of fares collected, the booth occupant may operate overrides 134 to signal a fare evasion to controller 88. This causes the controller to initiate a fare evasion mode wherein the entry mode is aborted and the controller maintains the paid side door 26 closed and re-opens door 24 to the unpaid side. In fare evasion mode, the controller may also operate displays 60, 62 to read “DO NOT ENTER”. The booth occupant may speak to those in the vestibule through intercom 100 (FIG. 6). Once the controller has cycled (opened and closed) the unpaid side door, the controller will leave the fare evasion mode and return to its ready state.

After a fare is collected, the controller also launches an (e.g., thirty second) abort timer. If no one enters vestibule 12 before the abort timer expires, then on its expiry, the controller causes the unpaid side door to close again and abort the entry mode. It would then be necessary for would-be entrants to speak to a booth 130 occupant via intercom 50 (FIG. 1) to explain the situation and request special treatment or simply deposit a further token (or further tokens) in the fare collection box 40 to re-initiate the entry mode. (In an alternative embodiment, feedback from the controller 88 to booth 130 could explain the circumstance to the booth attendant who could then take appropriate action.)

Optionally, camera 90 may be located outside the vestibule 12 so as to have the access portal 10 and the surrounding area at the unpaid side 18 in its field of view. In such circumstances, the controller 88 may signal indicator 122 when “token collected signals” are received by the fare collection box 40 rather than after the unpaid side door has been cycled open and closed. As a further option in this regard, the fare collection box itself could signal not only the controller 88, but it could also simultaneously directly signal indicator 132, in which case the fare collection box may be considered as part of the controller.

An exit mode commences when the controller is in its ready state and the exit pushbutton 70 is pushed. In such case, the controller changes display 60 to read “BUSY” and display 62 to read “ENTER”. Then, (possibly after a short—e.g., one second—time delay) the controller causes the paid side door to open. When a user enters the vestibule 12, the paid side infrared sensor signals the controller. This causes the controller to launch the paid side door timer. Once this timer expires, the controller will cause the paid side door to close and the unpaid side door to open immediately thereafter. When an occupant of the vestibule leaves, this results in a signal from sensor 86 to the controller causing the controller to launch an unpaid side door timer and re-close the unpaid side door after expiry of this timer.

If no-one enters the vestibule before the paid side door timer expires, the controller re-closes the paid side door and the exit mode is aborted. If no-one leaves the vestibule before the unpaid side door timer expires, entrapment may occur, as aforedescribed.

When the controller is in exit mode, it will not respond to any additional signals received from exit pushbutton 70 or any signals received from fare collection box 40. When the controller is in entry mode, it will not respond to any signals received from exit pushbutton 70.

The overrides 134 may also lock controller 88 in its ready state to provide a night lock. Additionally, the controller may be programmed to respond in a suitable fashion to other events, such as a fire alarm (where, for example, both doors 24 and 26 could be opened and left open).

If booth 130 is positioned so that an occupant has a sight line into vestibule 12, camera 90 and display 136 may not be needed.

While the passenger assistance intercoms 50 and 82 and exit request button 70 have been illustrated as mounted on pedistals, equally, they may be wall-mounted, or mounted in some other suitable fashion. Additionally, alternate arrangements may be used for the fare collection box 40.

It should be apparent from the foregoing that the access portal 10 is suited for use by those with impaired mobility, such as an individual in a wheelchair, or a person on crutches. Additionally, the portal is suited for use by any person having an attendant. The portal can also accommodate a user bringing large belongings as, for example, a person with a large stroller.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

1. An access portal for separating an unpaid side of a controlled entry barrier from a paid side, said portal comprising:
a vestibule for connecting the paid and unpaid sides of said controlled entry barrier;
a first door for separating the vestibule from the unpaid side of said controlled entry barrier;
a second door for separating the vestibule from the paid side of said controlled entry barrier; and
a controller for operable connection to a fare collection box for, upon receiving an indication of a collected fare, monitoring for a further indication of a collected fare, said controller further for, at the conclusion of said monitoring, cycling said first door, and subsequently, said second door.

2. The access portal of claim 1 wherein said monitoring concludes at the earlier of expiry of an interval and said controller receiving a pre-set maximum number of indications of a collected fare.

3. The access portal of claim 2 wherein said maximum number is two.

4. The access portal of claim 1 further comprising:
a signaling path for providing a human perceptible signal to a manned fare collection booth indicative of a number of fares collected by said box during said monitoring.

5. The access portal of claim 1 wherein said controller is also for receiving a manual override from said manned collection booth to preclude opening of said second door.

6. The access portal of claim 1 further comprising:
a user actuatable exit requestor for said paid side;
said controller operably connected to said exit requestor for cycling said second door and, subsequently, said first door when said exit button is activated.

7. The access portal of claim 1 further comprising a camera for use in providing an indication of a number of people in said vestibule

8. The access portal of claim 7 wherein said camera is for providing said indication to a manned fare collection booth.

9. The access portal of claim 1 further comprising a control room extending from one of the walls which defines said vestibule.

10. The access portal of claim 9 wherein said first door and said second door are pocket doors, being received in said control room, when open.

11. The access portal of claim 1 wherein said vestibule is floorless.

12. The access portal of claim 1 further comprising a lower track for each of said first door and said second door, said lower track for recessed installation in a pre-existing floor on which said access portal is installed.

13. The access portal of claim 1 further comprising a display for at least one of said unpaid side of said portal and said paid side of said portal operationally connected to said controller, for indicating an operational status of said portal.

14. The access portal according to claim 2 further comprising a manually activated intercom for communication between said vestibule and said manned fare collection booth.

15. The access portal of claim 1 further comprising said fare collection box and wherein said fare collection box has a fare token receptor and a fare card reader.

16. An access portal of claim 1 further comprising a sensor for each of the first and second doors, said sensor signaling said controller when one or more users enter or exit said vestibule.

17. An access portal for controlled entry to a mass transit system, said portal comprising:
a vestibule for connecting the paid and unpaid sides of a controlled entry barrier;
a first door for separating the vestibule from the unpaid side of said controlled entry barrier;
a second door for separating the vestibule from the paid side of said controlled entry barrier; and
a controller for operable connection to a fare collection box for cycling said first door and, subsequently, said second door when a fare is collected by said box.

18. The access portal according to claim 17, wherein the vestibule is floorless.

19. The access portal according to claim 17 further comprising a lower track for each of said first and second doors recessed into a floor upon which said portal is installed, such that said lower track is substantially flush with a surface of said floor.

20. A method of operating an access portal separating an unpaid side of a controlled entry barrier from a paid side, said portal comprising:
a vestibule for connecting said paid and unpaid sides of said controlled entry barrier,
a first door for separating the vestibule from the unpaid side of said controlled entry barrier,
a second door for separating the vestibule from the paid side of said controlled entry barrier, and
a fare collection box for said unpaid side, said method comprising:
receiving an indication of a collected fare,
upon said receiving, monitoring for a further indication of a collected fare, after said monitoring, cycling said first door, and subsequently, said second door.

21. The method of claim 20 wherein said monitoring concludes at the earlier of expiry of an interval and receiving a pre-set maximum number of indications of a collected fare.

22. A computer readable medium containing computer executable instructions, which when executed on a controller of an access portal separating an unpaid side of a controlled entry barrier from a paid side, said portal comprising: a vestibule for connecting said paid and unpaid sides of said controlled entry barrier, a first door for separating the vestibule from the unpaid side of said controlled entry barrier, a second door for separating the vestibule from the paid side of said controlled entry barrier, and a fare collection box for said unpaid side, cause said controller to:
on receiving an indication of a collected fare, monitor for a further indication of a collected fare, and
after said monitoring, cycling said first door, and subsequently, said second door.
